(19) United States
(12) Patent Application Publication
(10) Pub. No.: US 2009/0243453 A1
(43) Pub. Date: Oct. 1, 2009

(54) GASKET AND REFRIGERATOR THEREWITH

(75) Inventors: Byeong Gyu Kang, Gyeongsangnam-do (KR); Ki Hoon Song, Gyeonggi-do (KR); Jeong Ho Shin, Daejeon (KR); Jong Seok Yoon, Gyeonggi-do (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 12/302,785

(22) PCT Filed: Mar. 15, 2007
(86) PCT No.: PCT/KR2007/001283

§ 371 Date: Nov. 26, 2008

(30) Foreign Application Priority Data
Aug. 17, 2006 (KR) 10-2006-0077566

(51) Int. Cl. F25D 23/02; E06B 7/16

(52) U.S. Cl. 312/405; 49/482.1; 49/478.1

(57) ABSTRACT

The present invention relates to gaskets (120), and more particularly, to a gasket (120) which enables, not only to seal a gap between two components, but also easy attachment/detachment of the two components; and a refrigerator therewith. The gasket (120) includes a case (124) having a sealing member (122) attachable/detachable to/from a predetermined thing for sealing a gap when the sealing member (122) is attached, a close contact piece (126) for making close contact to other thing, and a plurality of supporting pieces (130, 132) connected between the close contact piece (126) and the case (124) so that one side of an attached surface of the sealing member (122) is detached from the predetermined thing at first if the other thing is pulled forward.

### TECHNICAL FIELD

The present invention relates to gaskets, and more particularly, to a gasket which enables, not only to seal a gap between two components, but also easy attachment/detachment of the two components; and a refrigerator therewith.

### BACKGROUND ART

In general, the gasket, which is a packing for placing between a connection or a joint portion of two components, is mostly used as means for sealing the gap between the two components to prevent gas or liquid from leaking, or means for attenuating impact between the two components.

The gasket of the present invention may also be provided between the two components fastened to one of the components for preventing fluid from leaking or performing an attenuating function. For convenience sake, the gasket will be described, taking a gasket provided to a refrigerator door, as an example.

FIG. 1 illustrates a perspective view of a related art refrigerator.

The refrigerator maintains a storage space in the refrigerator at a low temperature state as an evaporator in the refrigerator absorbs heat from an inside of the refrigerator and discharges the heat to an outside of the refrigerator through a condenser.

Referring to FIG. 1, the refrigerator has an exterior constructed of a body 10 and a plurality of refrigerator doors 20 and 22.

Formed inside of the body 10, there are a freezing chamber (not shown) for storing things in a frozen state, and a refrigerating chamber 30 for storing things in a refrigerated state, which are opened/closed with a freezing chamber door 20 and a refrigerating chamber door 22, respectively.

Each of the freezing chamber door 20 and the refrigerating chamber door 22 has a gasket 40 fixedly secured to an inside circumference, i.e., a door liner thereof. The gasket 40 seals cold air from leaking to an outside of the refrigerator from the inside of the refrigerator, as well as seals heat from entering into the inside of the refrigerator from an outside of the refrigerator. That is, the gasket 40 is provided for heat insulation between the outside and the inside of the refrigerator. The gasket 40 also serves to attenuate impact between the refrigerator doors 20 and 22 and the body 10.

FIG. 2 illustrates a section of a related art gasket 40.

Referring to FIG. 2, the gasket 40 is provided with a magnet 42 enclosed with a magnet case 44. Spaced from the magnet case 44, the gasket 40 is provided with a close contact piece 46 to be in close contact with the door liner of the refrigerator door 20 or 22, with a fastening hook 48 projected therefrom.

The fastening hook 48 is placed in the refrigerator door 20 or 22 for fastening the gasket 40 to the refrigerator door 20 or 22.

Connected between a front of the magnet case 44 and the close contact piece 46, there are one pair of supporting pieces 50. The supporting pieces 50 support the magnet 42 and form a damping space filled with air.

The supporting piece 50 has a left side supporting piece 50′ and a right side supporting piece 50″, spaced from each other. That is, the left side supporting piece 50′ has a rear edge connected in the vicinity of a left edge of a front of the magnetic case 44, and the right side supporting piece 50″ has a rear edge connected in the vicinity of a right edge of the magnetic case 44. Front edges of the one pair of the supporting pieces 50 are connected to the close contact piece 46 with a predetermined distance therebetween.

Accordingly, a distance between the rear edges both of the left side supporting piece 50′ and the right side supporting piece 50″ which are connected to the magnetic case 44, and a distance between the front edges both of the left side supporting piece 50′ and the right side supporting piece 50″ which are connected to the close contact piece 46 are similar.

Moreover, there is a reinforcing supporting piece 52 on a right side of the magnetic case 44 additionally, to form one more damping space.

The gasket 40 having above structure is selectively attached to the refrigerator body 10 in a state the gasket 40 is mounted to the refrigerator door 20 or 22, for sealing the gap between the refrigerator door 20 or 22 and the refrigerator body 10. That is, there is a metal frame on an inside of a front circumference of the refrigerator body 10, to which the magnet 42 is attached, so that the refrigerator door 20 or 22 and the refrigerator body 10 are in close contact.

FIG. 3 illustrates steps of the gasket 40 detaching/attaching from/to the refrigerator body 10 in a state the gasket 40 is mounted to the refrigerator door 20 or 22, schematically.

FIG. 3A illustrates the refrigerator door 20 or 22 in a closed state, when the magnet 42 is attached to the metal frame (an outer case) inside of the body 10 by magnetism.

In this state, the user pulls the refrigerator door 20 or 22 forward, to open the refrigerator. In this instance, as shown in FIG. 3B, as the one pair of supporting pieces 50 which are folded are unfolded, a distance between the refrigerator door 20 or 22 and the body becomes the greater, gradually.

At the end, if the one pair of the supporting pieces 50 are unfolded fully, the magnet 42 moves away from the body 10 as shown in FIG. 4C. In this instance, because lengths of the one pair of the supporting pieces 50 are almost the same, an entire surface of the magnet 42 moves away from the body 10 at a time.

However, a structure of the foregoing gasket 40 has the following problems.

As reviewed above, as shown in FIG. 3, since the one pair of gaskets 40 have similar lengths and rear edges thereof are connected to a left side and a right side of the magnet case 44 respectively, an entire rear surface of the magnet 42 moves away from the body 10 at the same time. Accordingly, the user is required to apply substantial force to the refrigerator door 20 or 22.

This makes opening of the refrigerator door 20 or 22 more difficult for a recent refrigerator type in which a total weight of the refrigerator door 20 or 22 becomes the heavier as the refrigerator door 20 or 22 is provided with the more drawer type door baskets.

### DISCLOSURE OF INVENTION

### Technical Problem

An object of the present invention devised to solve the problem lies on providing a gasket which enables, not only to seal between two components, but also attachment/detachment of the two components only by application of low force, and a refrigerator therewith.

### Technical Solution

To achieve these objects and other advantages and in accordance with the purpose of the invention, as embodied and broadly described herein, a gasket includes a case having a sealing member attachable/detachable to/from a predetermined thing for sealing a gap when the sealing member is attached, a close contact piece for making close contact to other thing, and a plurality of supporting pieces connected between the close contact piece and the case so that one side of an attached surface of the sealing member is detached from the predetermined thing at first if the other thing is pulled forward.

In another aspect of the present invention, a refrigerator includes a body, a door mounted to the body so as to be able to open/close, and a gasket for sealing a gap between the body and the door when the door is closed, wherein the gasket includes a case having a sealing member attachable/detachable to/from body for sealing a gap when the sealing member is attached, a close contact piece for making close contact to the door, and a plurality of supporting pieces connected between the close contact piece and the case so that one side of an attached surface of the sealing member is detached from the body at first if the door is pulled forward.

### ADVANTAGEOUS EFFECTS

The gasket of the present invention permits to open a door with force lower than before.

Moreover, according to a refrigerator having the gasket of the present invention applied thereto, because the sealing member can be detached from the body starting from one side thereof at the time of opening of the door, the user can open the door more easily. That is, at the time of opening of the door, since an entire attached surface of the magnet is not detached from the body at a time like the related art, force required for opening the door is reduced, significantly.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 illustrates a perspective view of a related art refrigerator.

FIG. 2 illustrates a section of a related art gasket provided to a related art refrigerator door.

FIG. 3 illustrates operation states of a related art gasket following opening of a door.

FIG. 4 illustrates a partial section of a gasket applied to a refrigerator door in accordance with a first preferred embodiment of the present invention.

FIG. 5 illustrates a section of a gasket in accordance with a first preferred embodiment of the present invention.

FIG. 6 illustrates sections showing operation states of the gasket in accordance with a first preferred embodiment of the present invention.

FIG. 7 illustrates a section of a gasket in accordance with a second preferred embodiment of the present invention.

FIG. 8 illustrates sections showing operation states of the gasket in accordance with a second preferred embodiment of the present invention.

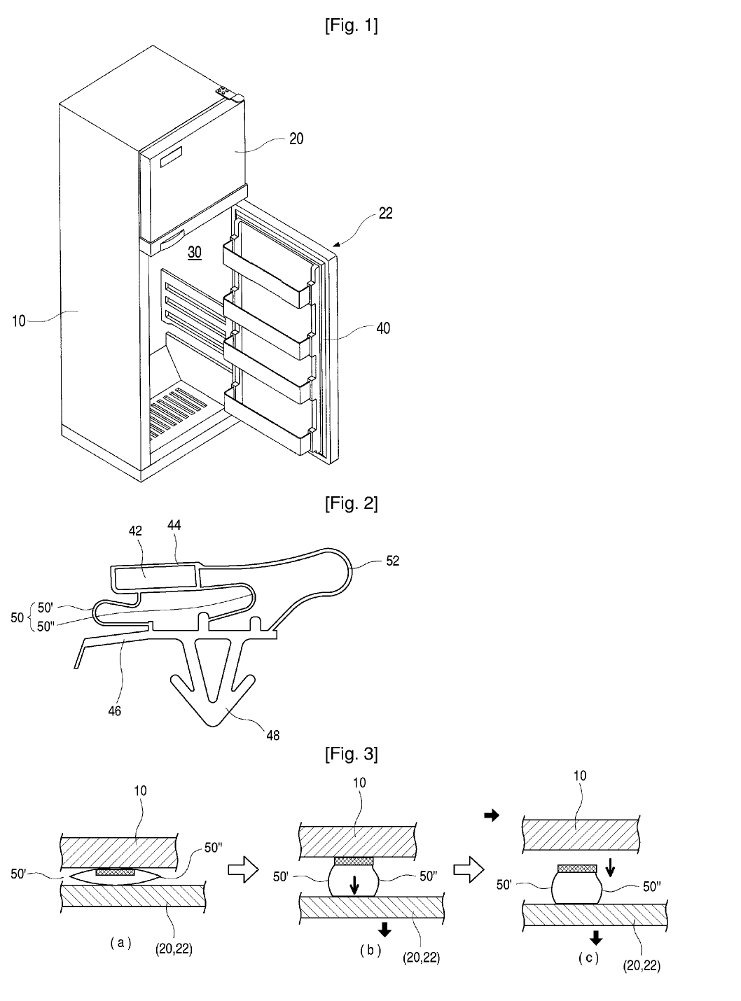

### BEST MODE FOR CARRYING OUT THE INVENTION

Reference will now be made in detail to the preferred embodiments of the present invention, examples of which are illustrated in the accompanying drawings.

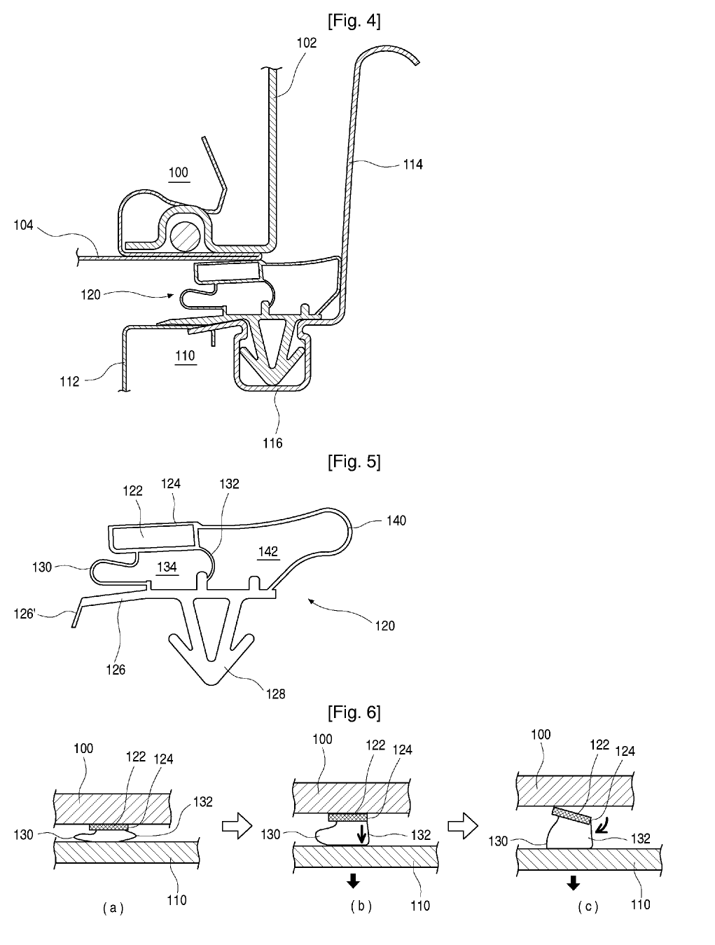

FIG. 4 illustrates a partial section of a gasket applied to a refrigerator door in accordance with a first preferred embodiment of the present invention, and FIG. 5 illustrates a section of a gasket in accordance with a first preferred embodiment of the present invention.

Referring to FIGS. 4 and 5, there is a door 110 rotatably mounted to a front of a body 100 of the refrigerator, for selective opening/closing of an inside of the refrigerator door.

The body 100 is enclosed with an inner case 102 and an outer case 104 with polyurethane foam therebetween for thermal insulation.

The outer case 104 is in general constructed of metal, and the inner case 102 is formed of ABS resin by vacuum bag molding. Accordingly, a sealing member 122 of the gasket 120 which will be described later is attached to the outer case 104 of metal.

The door 110 is enclosed with a door case 112 constructed of a steel plate and a door liner 114 of ABS resin, with polyurethane foam therebetween.

The door liner 114 has a hook socket 116 recessed therein. The hook socket 116 is a portion a fastening hook 128 of the gasket to be described later will be placed therein.

The gasket 120 is mounted between the body 100 and the door 110. More specifically, the gasket 120 is mounted to the door liner 114 on a back side of the door 110.

The gasket 120 is detachably mounted to the body 100, and includes a case 124 having a sealing member 122 for sealing a gap between the body 100 and the door 110 in a case the door 110 is closed, a close contact piece 126 for making close contact with the door liner 114, a fastening hook 128 for fixedly placing in the door liner 114, and one pair of supporting pieces 130 and 132 connected between the case 124 and the close contact piece 126 such that one side of an attached surface of the case 124 is detached from the body 100 at first if the door 110 is pulled.

Preferably, the sealing member 122 may be a magnet. In general, the magnet is a substance with magnetism which can pull iron, such as ore having magnetism in nature, typically, magnetite. Though the magnet may be formed by artificially magnetizing a steel piece, it is preferable that a permanent magnet is used, which has magnetism even though there is no external magnetic field around the magnet.

As shown, the case 124, enclosing the sealing member 122, has a rectangular section.

The close contact piece 126 in close contact with the back side of the door 110, i.e., an edge of the door liner 114, has a predetermined width. The close contact piece 126 has a left edge with a bent forward flange 126′ extended from the left edge for enhancing the close contact with the door 110.

The fastening hook 128, a forward projection from the close contact piece 126, is placed in the hook socket 116 in the door liner 116. Accordingly, the fastening hook 128 and the hook socket 116 have shapes matched to each other.

The one pair of the supporting pieces 130 and 132, having opposite ends connected to the close contact piece 126 and the magnet case 124 respectively, to form a first damping space 134. Preferably, the one pair of supporting pieces 130 and 132 may be formed of a soft material to allow free bending.

The first damping space 134 is filled with air. Therefore, the first damping space 134 attenuates impact caused between the door 110 and the case 100 when the door 110 is closed.

The one pair of supporting pieces 130 and 132 are a left side supporting piece 130 having one edge connected to one side of the case 124, i.e., a left side edge of a front of the case 124, and a right side supporting piece 132 having one edge connected to the other side of the case 124, i.e., a right side edge of the front of the case 124. That is, one edges of the left side supporting piece 130 and the right side supporting piece 132 are connected to in the vicinity of the left side edge, and the right side edge of the front of the case 124, respectively.

The other edges of the left side supporting piece 130 and the right side supporting piece 132 are connected to the close contact piece 126 respectively, spaced a predetermined distance away from each other.

The one pair of supporting pieces 130 and 132 have lengths different from each other. That is, the left side supporting piece 130 and the right side supporting piece 132 are formed to have lengths significantly different from each other. In more detail, as shown, the left side supporting piece 130 has a length significantly longer than the right side supporting piece 132.

The lengths of the one pair of the supporting pieces 130 and 132 are formed differently thus for making asymmetry of the supporting pieces 130 and 132 that supporting the magnet 122 greater to open the door 110, more easily.

There is a reinforcing supporting piece 140 formed on a right side of the case 124, additionally. The reinforcing supporting piece 140 forms one more damping space at the gasket 120. That is, the reinforcing supporting piece 140 has a length greater than any one of the supporting pieces 130 and 132, having a rear edge connected to a right side edge of a rear of the magnet case 124 and a front edge connected to a right side edge of the close contact piece 126.

Accordingly, there is a second damping space 142 formed between the reinforcing supporting piece 140 and the right side supporting piece 132, for attenuating impact to the door 110 and the body 100 when the door 110 hits the body 100, and sealing the gap between the door 110 and the body 100.

FIG. 6 illustrates sections showing operation states of the gasket 120 in accordance with a first preferred embodiment of the present invention, schematically.

Referring to FIG. 6, the sealing member 122 of the gasket 120 is attached to the outer case 104 at the front of the body 100 selectively. For an example, if the sealing member 122 is a magnet, the sealing member 122 can be attached to the outer case 104 of metal of the body 100. In a case the outer case 104 is constructed of a non-metallic material, a metallic material may be provided to an inside of the body 100 additionally for allowing the magnet to be attached thereto.

FIG. 6A illustrates a door 110 closed state. In this instance, since the sealing member 122 is attached to the body 100, the gap between the body 100 and the door 110 is sealed with the gasket 120, and, as shown, the left side supporting piece 130 and the right side supporting piece 132 are bent.

Referring to FIG. 6B, under this state, if the user pulls the door 110 forward, the one pair of the supporting pieces 130 and 132 are unfolded following the forward movement of the door 110. Since the left side supporting piece 130 has a length greater than the right side supporting piece 132, the right side supporting piece 132 is unfolded fully at first.

Accordingly, after the right side supporting piece 132 is unfolded fully, the sealing member 122 is detached from the body 100 by an external force that pulls the door 110 forward. In this instance, as shown in FIG. 6C, a right edge of the sealing member 122 is detached from the body 100 at first. This is because the left side supporting piece 130 has a length greater than the right side supporting piece 132.

In succession, as the door 110 is pulled forward further, the left side supporting piece 130 is also unfolded fully, to detach the left edge of the sealing member 122 from the body 100, too.

Thus, because, if the user pulls the door 110 forward, the sealing member 122 can be detached from the body 100 starting from one of the edges (i.e., the right edge of the sealing member 122 in the embodiment) of the sealing member 122, the gasket 120 of the present invention permits the user to open the door 110 easily with force smaller than before.

Though the embodiment shows the one pair of the supporting pieces 130 and 132, the concept of the present invention is not limited to a number of the supporting pieces, and there may be more than two supporting pieces in the present invention.

For an example, if there is three supporting pieces, edges of the supporting pieces are connected to the case 124 starting from the left side edge of the front to the right side edge of the front in succession. Lengths of the three supporting pieces may be formed to make the asymmetry greater as described before. That is, the three supporting pieces may be formed such that the lengths become the shorter as it goes from the left side edge of the front of the case 124 toward the right side edge of the front of the case 124 the more.

Therefore, if the user pulls the door 110 forward, since the supporting pieces can be detached from the body 100 starting from the supporting piece connected to the right side edge of the case 124 to the supporting piece connected to the left side edge of the case 124 in succession accordingly, the user can open the door 110 with force lower than before.

Moreover, if there are three supporting pieces thus, the supporting pieces can be connected to the case 124 more firmly than a case there are one pair of the supporting pieces 130 and 132.

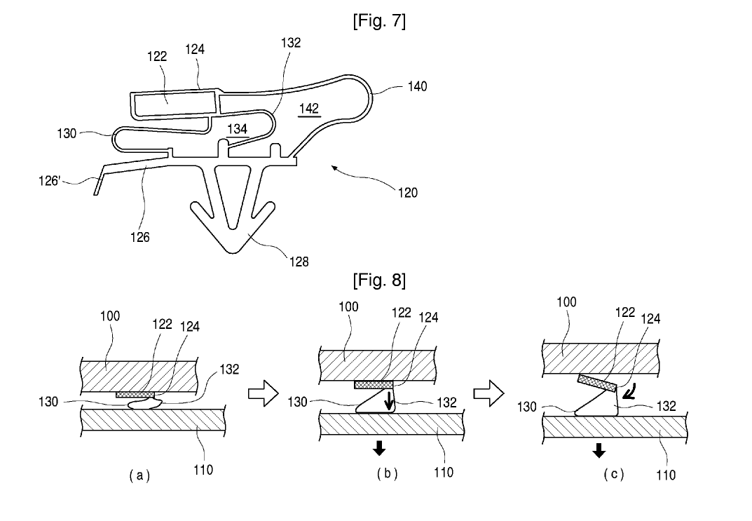

FIG. 7 illustrates a section of a gasket 120 in accordance with a second preferred embodiment of the present invention.

Referring to FIG. 7, most of a structure of the gasket 120 in accordance with a second preferred embodiment of the present invention is identical to a structure of the first embodiment, except that attached positions and lengths of the one pair of the supporting pieces 130 and 132 are different from the first embodiment.

The gasket 120 in accordance with a second preferred embodiment of the present invention will be described in detail, focusing on the differences.

Though the left side supporting piece 130 and the right side supporting piece 132 have lengths different from each other in the first embodiment, the left side supporting piece 130 and the right side supporting piece 132 do not necessarily require their lengths to be different from each other in the second embodiment. That is, in the second embodiment, lengths of the left side supporting piece 130 and the right side supporting piece 132 may or may not be different.

However, a connection position of the left side supporting piece 130 is different from the first embodiment. That is, in the first embodiment, though one edge of the left side supporting piece 130 is connected to in the vicinity of the left side edge of the front of the case 124, in the second embodiment, one edge of the left side supporting piece 130 is formed in the vicinity of the right side edge of the front of the case 124.

In more detail, one edges of the one pair of the supporting pieces 130 and 132 are connected to the case 124 at positions adjacent to each other. Of course, as shown in FIG. 7, in this case, the one edges of the left side supporting piece 130 and the right side supporting piece 132 may be connected at the same position perfectly, in order to prevent the sealing member 122 from moving, it is preferable that the one edges of the left side supporting piece 130 and the right side supporting piece 132 are connected at positions spaced slightly away from each other.

If both of the one pair of the supporting pieces 130 and 132 are connected to the one edge of the front of the case 124, since both of the supporting pieces 130 and 132 pull the right side edge of the case 124 at the time the door 110 is opened, the right side edge of the sealing member 122 can be detached from the body at first.

FIG. 8 illustrates sections showing operation states of the gasket in accordance with a second preferred embodiment of the present invention.

Alike FIG. 6A, FIG. 8A illustrates a closed state of the door 110. In this instance, since the sealing member 122 is attached to the body 100, the gap between the body 100 and the door 110 is sealed with the gasket 120, and, as shown in FIG. 8A, the left side supporting piece 130 and the right side supporting piece 132 are bent.

Referring to FIG. 8B, under this state, if the user pulls the door 110 forward, the one pair of the supporting pieces 130 and 132 are unfolded following the forward movement of the door 110. In this instance, as shown in FIG. 8B, though both the left side supporting piece 130 and the right side supporting piece 132 may be unfolded fully at the same time, in some cases, one of the left side supporting piece 130 and the right side supporting piece 132 may be unfolded fully at first. This is because, as described before, the lengths of the left side supporting piece 130 and the right side supporting piece 132 may or may not be different.

After at least one of the left side supporting piece 130 and the right side supporting piece 132 is unfolded fully thus, the left edge of the sealing member 122 is detached from the body 100 by an external force that pulls the door 110 forward. That is, as shown in FIG. 8C, the right edge of the sealing member 122 is detached from the body 100 at first. This is because both of the right side supporting piece 132 and the left side supporting piece 130 are connected to the right edge of the case 124.

Then, as the door 110 is pulled further, the left edge of the sealing member 122 is also detached from the body 100, by which the door 110 is opened.

However, though the embodiment describes that one edges of the one pair of the supporting pieces 130 and 132 are connected to any one side of the case 124, i.e., to the right edge of the case 124 adjacent to each other, opposite to this, the other edges of the one pair of the supporting pieces 130 and 132 may be connected to any one side of the close contact piece 46 adjacent to each other.

Then, alike a case one edges of the one pair of the supporting pieces 130 and 132 are connected to any one side of the case 124 adjacent to each other, as the user pulls the door 110 forward, any one side of an attached surface of the sealing member 122 can be detached from the body 100 at first. In this instance, it is preferable that the positions of the other edges of the one pair of the supporting pieces 130 and 132 connected to the close contact piece 46 adjacent to each other is opposite to any one side of the case 124 (for an example, the left side or right side of the front of the case 124).

Then, when the user pulls the door 110 forward, force that the one pair of the supporting pieces 130 and 132 pull the case 124 can be focused on any one side of the sealing member 122, causing that any one side of the sealing member 122 is detached from the body 100 at first accordingly. Eventually, the user can open the door 110 easily with force smaller than before.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention relates to gaskets, and more particularly, to a gasket which enables, not only to seal a gap between two components, but also easy attachment/detachment of the two components; and a refrigerator therewith.

The gasket of the present invention enables to detach any one side of the sealing member at first by making lengths of a plurality of supporting pieces which support the sealing member different from one another, or positions of the supporting pieces connected to the case to be adjacent to one another.

Accordingly, because the sealing member can be detached from the body starting from one side thereof at the time of opening of the door, the door having the gasket of the present invention applied thereto can be opened with low force easily. That is, at the time of opening of the door, since an entire attached surface of the magnet is not detached from the body at a time like the related art, force required for opening the door is reduced, significantly.

1. A gasket comprising:
a case having a sealing member attachable/detachable to/from a predetermined thing for sealing a gap when the sealing member is attached;
a close contact piece for making close contact to other thing; and
a plurality of supporting pieces connected between the close contact piece and the case so that one side of an attached surface of the sealing member is detached from the predetermined thing at first if the other thing is pulled forward.

2. The gasket as claimed in claim 1, wherein the plurality of supporting pieces has lengths different from each other.

3. The gasket as claimed in claim 2, wherein the plurality of supporting pieces includes one pair of supporting pieces, with a left side supporting piece connected to one side of the case, and a right side supporting piece connected to the other side of the case.

4. The gasket as claimed in claim 1, wherein one edges of the plurality of supporting pieces is connected to one side of the case adjacent to one another.

5. The gasket as claimed in claim 1, wherein one edges of the plurality of supporting pieces is connected to one side of the close contact piece adjacent to one another.

6. The gasket as claimed in claim 5, wherein the one side of the close contact piece is opposite to a left side or right side of the case.

7. The gasket as claimed in claim 1, wherein the sealing member is a magnet.

8. The gasket as claimed in claim 1, wherein the plurality of supporting pieces is formed of a soft material which can be bent.

9. The gasket as claimed in claim 1, wherein the plurality of supporting pieces forms a damping space between the case and the close contact piece.

10. A gasket comprising:
a case having a sealing member attachable/detachable to/from a predetermined thing for sealing a gap when the sealing member is attached;
a close contact piece for making close contact to other thing; and
one pair of supporting pieces connected between the close contact piece and the case, and having lengths different from each other.

11. The gasket as claimed in claim 10, wherein the one pair of supporting pieces include a left side supporting piece connected to one side of the case, and a right side supporting piece connected to the other side of the case.

12. A gasket comprising:
a case having a sealing member attachable/detachable to/from a predetermined thing for sealing a gap when the sealing member is attached;
one pair of supporting pieces having one edges connected to one side of the case adjacent to each other;
a close contact piece having the other edges of the one pair of supporting pieces connected thereto, the close contact piece for making close contact to another thing.

13. A gasket comprising:
a case having a sealing member attachable/detachable to/from a predetermined thing for sealing a gap when the sealing member is attached;
one pair of supporting pieces having one edges connected to the case;
a close contact piece having one side the other edges of the one pair of supporting pieces connected thereto adjacent to each other, the close contact piece for making close contact to another thing.

14. A refrigerator comprising:
a body;
a door mounted to the body so as to be able to open/close; and
a gasket for sealing a gap between the body and the door when the door is closed;
wherein the gasket comprises;
a case having a sealing member attachable/detachable to/from body for sealing a gap when the sealing member is attached,
a close contact piece for making close contact to the door, and
a plurality of supporting pieces connected between the close contact piece and the case so that one side of an attached surface of the sealing member is detached from the body at first if the door is pulled forward.

15. The refrigerator as claimed in claim 14, wherein the plurality of supporting pieces has lengths different from each other.

16. The refrigerator as claimed in claim 15, wherein the plurality of supporting pieces includes one pair of supporting pieces, with a left side supporting piece connected to one side of the case, and a right side supporting piece connected to the other side of the case.

17. The refrigerator as claimed in claim 14, wherein one edges of the plurality of supporting pieces is connected to one side of the case adjacent to one another.

18. The refrigerator as claimed in claim 14, wherein one edges of the plurality of supporting pieces is connected to one side of the close contact piece adjacent to one another.

19. The refrigerator as claimed in claim 18, wherein the one side of the close contact piece is opposite to a left side or right side of the case.

20. The refrigerator as claimed in claim 14, wherein the sealing member is a magnet.

21. The refrigerator as claimed in claim 14, wherein the close contact piece includes a fastening hook for placing in a socket in the door for fastening the gasket thereto.

22. The refrigerator as claimed in claim 14, wherein the plurality of supporting pieces forms a damping space between the case and the close contact piece.

23. The refrigerator as claimed in claim 14, wherein the plurality of supporting pieces is formed of a soft material which can be bent.
